(19) United States
(12) Patent Application Publication
(10) Pub. No.: US 2014/0210798 A1
(43) Pub. Date: Jul. 31, 2014

(54) Digital Drawing Using A Touch-Sensitive Device To Detect A Position And Force For An Input Event

(71) Applicant: HEWLETT-PACKARD DEVELOPMENT COMPANY, L.P., (US)

(72) Inventor: Evan J. WILSON, Sunnyvale, CA (US)

(73) Assignee: HEWLETT-PACKARD DEVELOPMENT COMPANY, L.P., Houston, TX (US)

(21) Appl. No.: 13/755,906

(22) Filed: Jan. 31, 2013

(51) Int. Cl. G06F 3/033

(52) U.S. Cl. CPC G06F 3/033
USPC 345/179

(57) ABSTRACT

An example system includes a touch-sensitive device to detect a position and a force for an input event and generate input data indicative of the position and the force and a processor coupled to the touch-sensitive device. The processor receives the input data and generates digital ink data having a position based on the input data indicative of the position and having a digital ink characteristic based on the input data indicative of the force when the force for the input event is above a predetermined threshold. The processor also alters the position of a drawing cursor in response to a change in the position of the input event.

### BACKGROUND

A large variety of devices for providing input to computer systems are available. Touch-sensitive devices have found wide acceptance in both portable and desktop applications and in systems used by graphical artists due to their form factor and their potential for high resolution positional capability. Position information captured by a touch-sensitive device may be used in conjunction with force information captured by a force-sensitive stylus by associated digital drawing software to vary the thickness of digital ink shown in, for example, a drawing application. This enables graphic artists and the like to experience a more realistic digital drawing experience.

### BRIEF DESCRIPTION OF THE DRAWINGS

For a detailed description of various examples, reference will now be made to the accompanying drawings in which:

FIG. 1a-1c show various aspects of a system for digital drawing in accordance with various examples of the present disclosure;

FIG. 2 shows a flow chart of a method in accordance with various examples of the present disclosure; and

FIG. 3 shows a flow chart of additional steps of a method in accordance with various examples of the present disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct connection or through an indirect connection via other devices and connections.

As used herein, the term “digital drawing” when used as a verb or adjective (e.g., digital drawing technique) describes the act of creating a digital image file by interacting with a touch-sensitive device or other digital sensing device, for example with a user's finger, a stylus operated by the user, or the like. The term “digital drawing” when used as a noun refers to a representation of a drawing canvas, including any digital ink added to the drawing canvas. Digital drawing may include, for example, handwriting. Digital drawing may also refer to a digital image file created when saving a drawing canvas, including any digital ink added to the drawing canvas, to a computer memory.

As used herein, the term “drawing canvas” refers to the area in a drawing application in which a user can create a digital drawing.

As used herein, the term “input event” refers to an interaction between a user and an input device, such as a touch-sensitive device or other digital sensing device. For example, touching a stylus or the user's finger to a touch-sensitive device is an input event.

As used herein, the term “drawing cursor” refers to a movable indicator identifying a location on a drawing canvas that will be affected by an input event.

As used herein, the term “digital ink” refers to a digital representation (e.g., on a computer display) designed to mimic the appearance of ink on paper or other physical media.

As used herein, the term “digital ink data” refers to data indicating a position and thickness of digital ink. For example, digital ink data may indicate that digital ink is located 100 pixels to the right and down from the top-left corner of a drawing canvas and has a width of 2 pixels. Optionally, digital ink data may include data indicating a color, texture, or other effect applied to digital ink on the drawing canvas.

### DETAILED DESCRIPTION

In accordance with various examples of the present disclosure, a system and method for digital drawing enable a more realistic digital drawing experience, for example when using a drawing application, on a notepad computer, or when signing digital documents. In addition to the position of a user input event, a force-sensitive touch-sensitive device enables the generation of force information regardless of the mode of interaction. That is, force-sensing components exist below the surface of the touch-sensitive device to capture force information of an input event. As a result, a stylus, finger, or other input element may be equivalently used and force information is still generated by the force-sensitive touch-sensitive device. This allows for broader input flexibility and eliminates the need for a complex and expensive force-sensitive stylus; a stylus that is not force-sensitive is equally effective. Additionally, and as will be explained in further detail below, when the force of an input event is above a certain threshold, digital ink data is generated. However, if the force of an input event is below this threshold, no digital ink is generated although changes in position of the input event alter the position of a drawing cursor. Thus, a user is more easily able to identify the location of the drawing cursor prior to causing digital ink to be generated on a drawing canvas. Additionally, force information may be used to increase the accuracy of handwriting recognition and add additional security to authentication processes based on handwriting recognition.

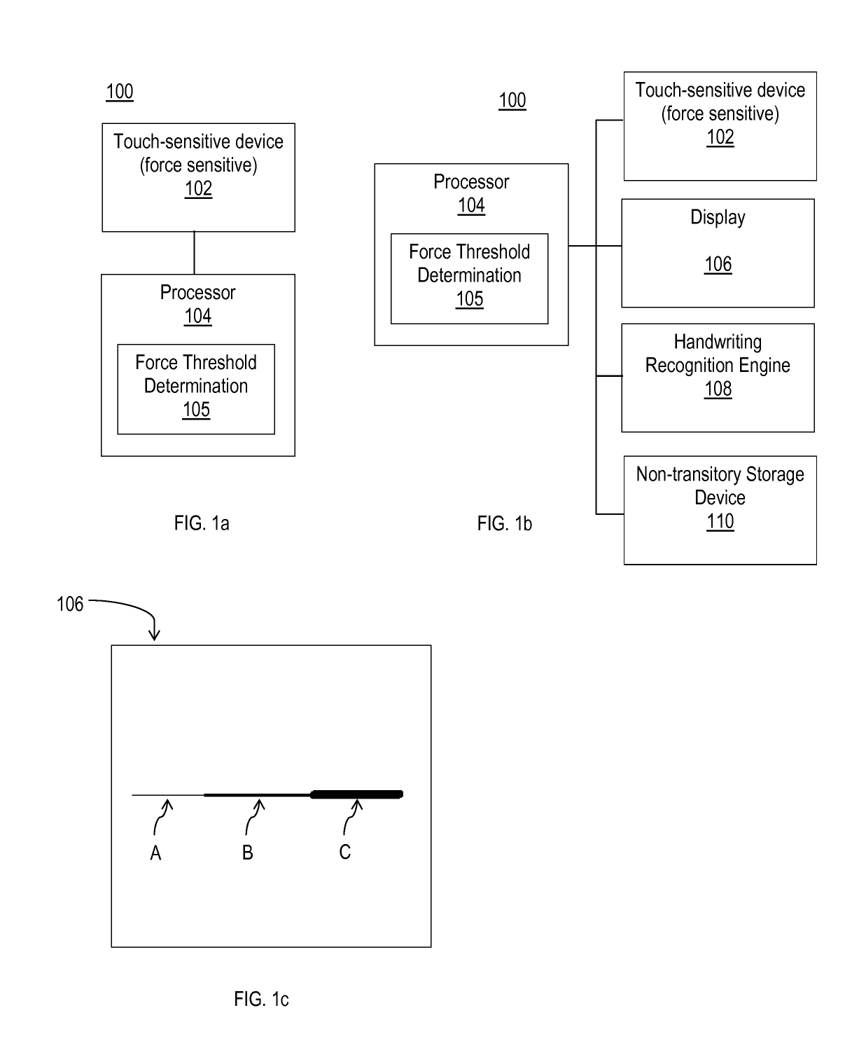

FIG. 1a shows a system 100, which may be a portion of a laptop computer, tablet PC, or other computing device. Additionally, the system 100 may be an external device that is coupled to a suitable computing device. The system 100 includes a touch-sensitive device 102 that detects a position and a force for a user input event. Reference to a force refers to the force of an input event, and does not refer to, for example, the pressure of the environment surrounding the touch-sensitive device 102. For example, when the touch-sensitive device 102 is not receiving an input event, there is no input force detected by the touch-sensitive device 102, however there are always forces acting on the touch-sensitive device 102 such as atmospheric pressure and gravity. The touch-sensitive device 102 may be, for example, a capacitive touch-sensitive device or a resistive touch-sensitive device. The system 100 also includes a processor 104 (e.g., a central processing unit (“CPU”)) coupled to the touch-sensitive device 102. In examples of the present disclosure, the processor 104 performs a force threshold determination 105, which will be explained in further detail below.

FIG. 1b shows the system 100 in further detail. For example, the system includes a display 106 to display drawing applications, a digital canvas, or other applications to a user. The system 108 also includes a handwriting recognition engine 108. In certain examples, the handwriting recognition comprises software that is executed by the processor 104, while in other examples the handwriting recognition 108 may comprise hardware or software that executes on a separate processor.

The touch-sensitive device 102 detects a position and a force for an input event. An input event may include a user touching a stylus, their finger, or other similar implement to the touch-sensitive device 102. As a result of detecting an input event, the touch-sensitive device 102 generates input data indicative of the position and force of the input event. For example, the input data may indicate that the position of the input event is 100 pixels down and to the right of the upper-left corner of the touch-sensitive device 102 and that the force of the input event is 200 grams. As explained above, because the touch pad 102 detects a force of an input event, an otherwise-conventional stylus may be used in place of an expensive and complex force-sensing stylus.

The processor 104 receives the input data from the touch pad 102 and, in accordance with examples of the present disclosure, generates digital ink data to be used with, for example, a digital drawing application executed by the processor 104. The processor 104 generates digital ink data having a position (e.g., relative to a drawing canvas of the digital drawing application) that is based on the position of the input data and having a thickness (e.g., a number of pixels) that is based on the force of the input data. This allows for a more lifelike digital drawing experience for a user, since the thickness of digital ink is dependent on the force of the user's input event.

Additionally, the processor 104 only generates digital ink data when the force of the input data is above a predetermined threshold (e.g., when the force threshold determination 105 indicates a force greater than 50 grams). The processor 104 will still alter the position of a drawing cursor on the display 106 in response to the change in position of an input event having a force below the threshold; however, no digital ink is generated. Thus, if a user desires to locate the drawing cursor's relative location to a drawing canvas shown on the display 106 prior to adding digital ink in a drawing application, the user may perform an input event having a force below the predetermined threshold. For example if the input event generates 25 grams of force, the cursor is moved but digital ink is not generated. Then, when the position of the user's input event changes, the processor causes the display 106 to display the drawing cursor moving, for example within the drawing application. In some examples, the force threshold for the generation of digital ink may be adjusted by the user.

Additionally, the system 100 in FIG. 1b includes a non-transitory storage device 110. The non-transitory storage device 110 may include random access memory (“RAM”), a hard disk drive, a compact disc read-only memory (“CD ROM”), Flash storage, and other non-transitory storage devices. The storage device 110 stores software that includes machine-readable instructions that may be executed by the processor 104 to implement some or all of the functionality described herein.

FIG. 1c shows an example display 106 (or subset of the display 106 corresponding to a drawing canvas of a drawing application) of digital ink having a varying thickness. The thickness of the digital ink increases as the force of an input event increases and correspondingly decreases as the force of an input event decreases. For example, the portion A of the digital ink corresponds to a low force above the predetermined threshold; the portion B of the digital ink corresponds to a moderate force above the predetermined threshold; and the portion C of the digital ink corresponds to a high force above the predetermined threshold.

In accordance with examples of the present disclosure, a digital ink characteristic is based on input data indicative of a force of an input event. In the above example, the digital ink characteristic is the thickness of digital ink. However, in other cases, the user may select a color, texture, or other drawing effect to be a digital ink characteristic applied to digital ink data when displayed in a drawing application. For example, prior to generating digital ink, the user may select in the drawing application that the digital ink should have the color red or be a dashed (rather than solid) line. Subsequently, when the user performs an input event, the processor 104 includes information indicative of such color or texture to the digital ink data, and thus the displayed digital ink appears as the user has specified. Additionally, drawing effects could be selected to vary with the force information received from the touch-sensitive device 102. For example, force values might correspond to different values on a color map, such as a pseudo-color “heat” map. As another example, varying force information could alter the spacing of dashes in a dashed line.

Referring back to FIG. 1b, the handwriting recognition engine 108 receives input data from the processor and matches an input event to a stored handwriting sample based on both the position and force values of the input event. If a match is determined, then handwriting recognition engine 108 may generate an authentication signal that causes the processor 104 to enable access to a computer implementing the system 100, or to certain programs executing on the computer. In some cases, the authentication signal may enable digital signature of a digital document; that is, if a match is determined, a digital signature is created in a document and if a match is not determined, the user is not able to digitally sign the document. By adding a force component to the authentication process, a larger number of data points are available for comparison to a handwriting sample than if merely position information was used. For example, a forgery of a user's signature may be positionally accurate, but with a uniform force, whereas the user's signature that corresponds to the handwriting sample comprises varied forces at different positions of the signature. In this way, handwriting or input event identification and authentication is enabled in a more precise manner. Furthermore, force information from a user input event, such as handwriting, may be used in addition to positional information to enhance the accuracy of handwriting recognition software. For example, force and position information are processed by a computing device to convert handwriting to digital text, which may be displayed back to the user or stored for searching purposes.

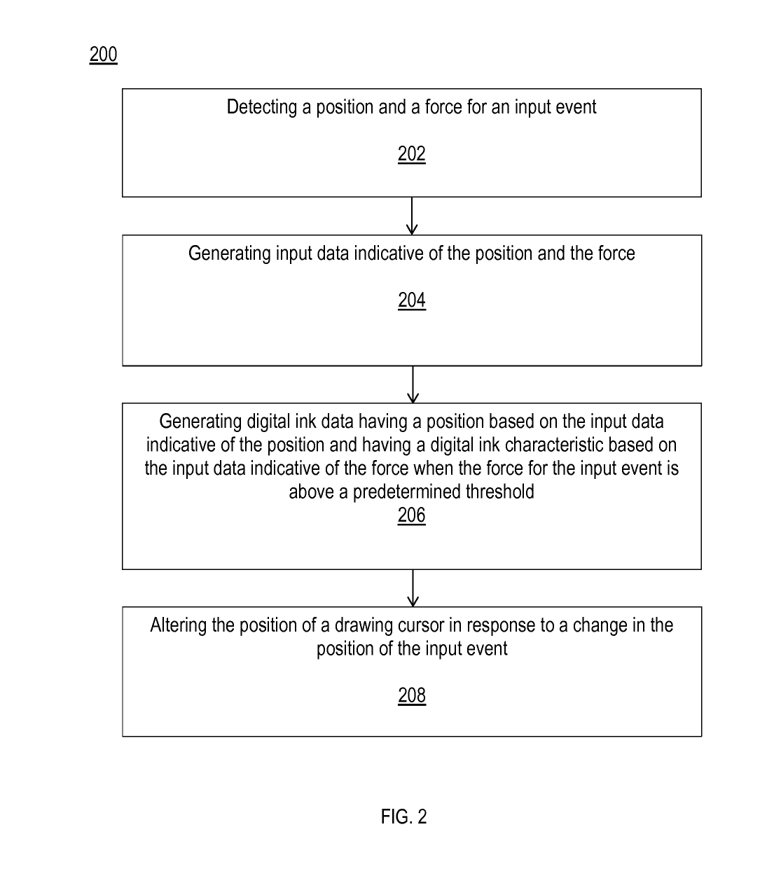

FIG. 2 shows a method 200 in accordance with various examples of the present disclosure. The actions provided in FIG. 2 can be performed in an order different than that shown and two or more actions may be performed in parallel. The method 200 may be performed by the processor 104, for example by executing instructions stored on a non-transitory computer readable storage device. The method 200 begins in block 202 with detecting a position and a force for an input event. As explained above, a touch pad 102 detects both the position and the force, which avoids the need for a complex and expensive stylus and enables the detection of force even where the input event comprises, for example the user using their finger to contact the touch pad.

The method 200 continues in block 204 with generating input data indicative of the position and the force. In some cases the touch pad 102 may generate the input data while in other cases the processor 104 generates the input data based on received position and force values from the touch pad 102. The method 200 continues further in block 206 with generating digital ink data having a position based on the input data indicative of the position and having a thickness based on the input data indicative of the force when the force for the input event is above a predetermined threshold. Finally, the method 200 concludes in block 208 with altering the position of a drawing cursor in response to a change in the position of the input event. As explained above, digital ink data is only generated when the force of the input data is above a predetermined threshold (e.g., 50 grams). The position of the drawing cursor is altered (e.g., on the display 106) in response to the change in position of an input event having a force below the threshold; however, no digital ink is generated. Thus, if a user desires to locate the drawing cursor's relative location to a drawing canvas shown on the display 106 prior to adding digital ink in a drawing application, the user may perform an input event having a force below the predetermined threshold. Then, when the position of the user's input event changes, the processor causes the display 106 to display the drawing cursor moving, for example within the drawing application. In some examples, the force threshold for the generation of digital ink may be adjusted by the user.

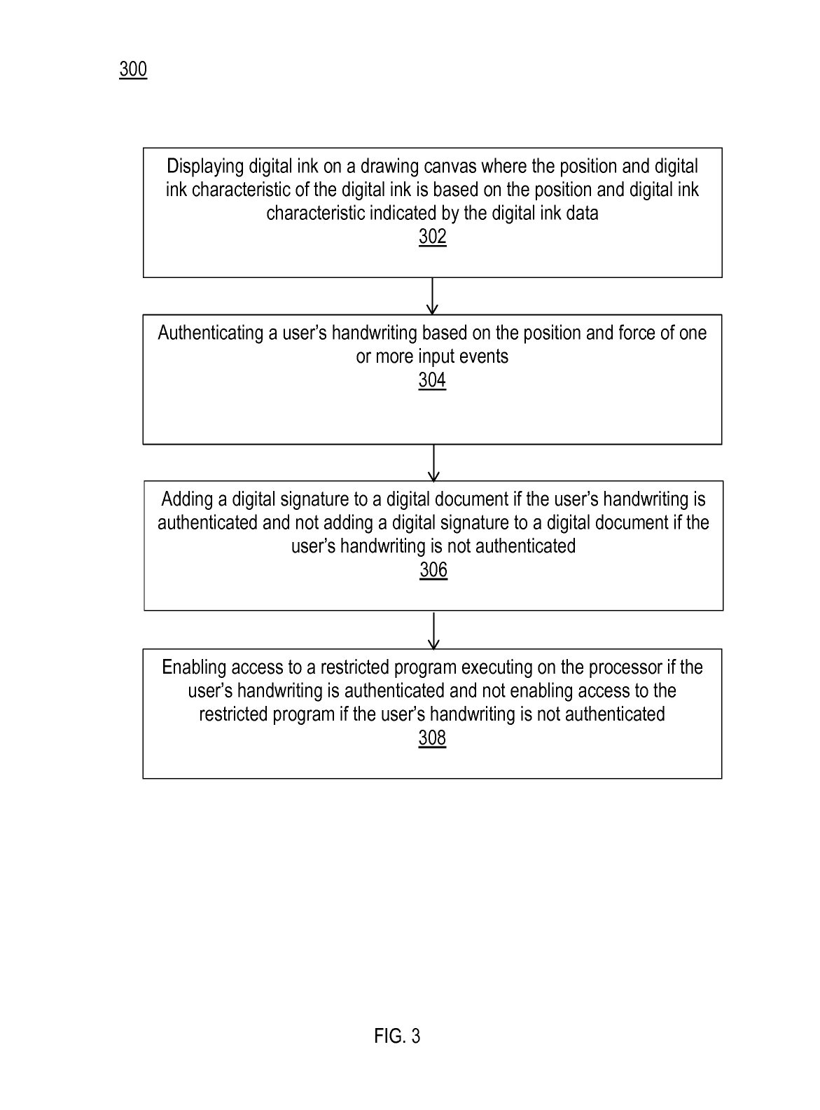

FIG. 3 shows additional steps 300 that may be performed in addition to those steps explained above with respect to the method 200 of FIG. 2. As above, the actions provided in FIG. 3 can be performed in an order different than that shown and two or more actions may be performed in parallel. The steps 300 may be performed by the processor 104, for example by executing instructions stored on a non-transitory computer readable storage device. In block 302, one additional step includes displaying digital ink on a drawing canvas where the position and thickness of the digital ink is based on the position and thickness indicated by the digital ink data. In block 304, another additional step includes authenticating a user's handwriting based on the position and thickness of one or more input events.

Continuing to block 306, an additional step includes adding a digital signature to a digital document if the user's handwriting is authenticated and not adding a digital signature to a digital document if the user's handwriting is not authenticated. Finally, in block 308, another additional step includes enabling access to a restricted program executing on the processor if the user's handwriting is authenticated and not enabling access to the restricted program if the user's handwriting is not authenticated.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system for digital drawing, comprising:
a touch-sensitive device to detect a position and a force for an input event and generate input data indicative of the position and the force; and
a processor coupled to the touch-sensitive device to:
receive the input data and generate digital ink data having a position based on the input data indicative of the position and having a digital ink characteristic based on the input data indicative of the force when the force of the input event is above a predetermined threshold; and
alter the position of a drawing cursor in response to a change in the position of the input event.

2. The system of claim 1 wherein the digital ink characteristic comprises thickness and the digital ink data indicates a greater thickness in response to a greater force and a lesser thickness in response to a lesser force.

3. The system of claim 1 wherein the processor causes a display to display digital ink on a drawing canvas, the position and digital ink characteristic of the digital ink is based on the position and digital ink characteristic indicated by the digital ink data.

4. The system of claim 1 wherein digital ink data further indicates at least one of a color and texture.

5. The system of claim 1 further comprising a handwriting recognition engine to authenticate a user's handwriting based on the position and force of one or more input events.

6. The system of claim 5 wherein the handwriting recognition engine enables signing of a digital document if the user's handwriting is authenticated and does not enable signing of a digital document if the user's handwriting is not authenticated.

7. The system of claim 5 wherein the handwriting recognition engine enables access to a restricted program executing on the processor if the user's handwriting is authenticated and does not enable access to the restricted program if the user's handwriting is not authenticated.

8. A method for digital drawing, comprising:
detecting, by a touch-sensitive device, a position and a force for an input event;
generating input data indicative of the position and the force;
generating digital ink data having a position based on the input data indicative of the position and having a digital ink characteristic based on the input data indicative of the force when the force for the input event is above a predetermined threshold; and
altering the position of a drawing cursor in response to a change in the position of the input event.

9. The method of claim 8 wherein the digital ink characteristic comprises thickness and the digital ink data indicates a greater thickness in response to a greater force and a lesser thickness in response to a lesser force.

10. The method of claim 8 further comprising displaying digital ink on a drawing canvas, the position and digital ink characteristic of the digital ink is based on the position and digital ink characteristic indicated by the digital ink data.

11. The method of claim 8 wherein digital ink data further indicates one of a color and texture.

12. The method of claim 8 further comprising authenticating a user's handwriting based on the position and force of one or more input events.

13. The method of claim 12 further comprising adding a digital signature to a digital document if the user's handwriting is authenticated and not adding a digital signature to a digital document if the user's handwriting is not authenticated.

14. The method of claim 12 further comprising enabling access to a restricted program executing on the processor if the user's handwriting is authenticated and not enabling access to the restricted program if the user's handwriting is not authenticated.

15. A non-transitory computer readable storage device containing instructions that, when executed by a processor, cause the processor to:
receive input data indicative of a position and a force of an input event detected by a touch-sensitive device;
generate digital ink data having a position based on the input data indicative of the position and having a digital ink characteristic based on the input data indicative of the force when the force for the input event is above a predetermined threshold; and
alter the position of a drawing cursor in response to a change in the position of the input event.

16. The non-transitory computer readable storage device of claim 15 wherein the digital ink characteristic comprises thickness and the digital ink data indicates a greater thickness in response to a greater force and a lesser thickness in response to a lesser force.

17. The non-transitory computer readable storage device of claim 15 wherein the instructions, when executed by the processor, further cause the processor to cause a display to display digital ink on a drawing canvas, the position and digital ink characteristic of the digital ink is based on the position and digital ink characteristic indicated by the digital ink data.

18. The non-transitory computer readable storage device of claim 15 wherein digital ink data further indicates one of a color and texture.

19. The non-transitory computer readable storage device of claim 15 wherein the instructions, when executed by the processor, further cause the processor to authenticate a user's handwriting based on the position and force of one or more input events.

20. The non-transitory computer readable storage device of claim 19 wherein the instructions, when executed by the processor, further cause the processor to add a digital signature to a digital document if the user's handwriting is authenticated and not add a digital signature to a digital document if the user's handwriting is not authenticated.
